(19) United States
(12) Patent Application Publication
(10) Pub. No.: US 2006/0121371 A1
(43) Pub. Date: Jun. 8, 2006

(54) Color filter having nanoparticles for liquid crystal display

(75) Inventor: Mei Ling Wu, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/294,225

(22) Filed: Dec. 5, 2005

(30) Foreign Application Priority Data
Dec. 3, 2004 (TW) 93137377

(51) Int. Cl. G02F 1/1335; G02B 5/20

(52) U.S. Cl. 430/7

(57) ABSTRACT

An exemplary color filter (10) for a liquid crystal display includes a substrate (100), a black matrix (110), and a photo-resist layer. The photo-resist layer defines a plurality of pixels (121). Each pixel includes a red sub-pixel (122), a green sub-pixel (124), and a blue sub-pixel (126). Each sub-pixel includes a plurality of nanoparticles (128). The black matrix is disposed in and around the sub-pixels. A material of the nanoparticles can be metal, alloy, a semiconductor, and/or a semiconductor compound. Light transmission of the exemplary color filter can be controlled by configuring the materials, diameters, and shapes of the nanoparticles accordingly. The color filter performs with high thermal resistance, high light transmission, and good contrast. In other embodiments, fluorescence of a color filter can also be controlled by configuring the materials, the diameters, and the shapes of the nanoparticles accordingly.

### FIELD OF THE INVENTION

The present invention relates to color filters, and more particularly to a color filter for a liquid crystal display (LCD) device.

### GENERAL BACKGROUND

Liquid crystal displays are commonly used as display devices for compact electronic apparatuses, because they are not only very thin but also provide good quality images with little power consumption.

A typical LCD device includes an LCD panel. The LCD panel includes two transparent substrates parallel to each other, and a liquid crystal layer disposed between the two substrates. In order to make the liquid crystal display device display a full-colored image, a color filter is usually employed in the device at one of the substrates. A typical color filter provides three primary colors: red, green, and blue (RGB). The color filter, the liquid crystal layer, and a switching element arranged on the substrate cooperate to make the liquid crystal display device display full-colored images.

As shown in FIG. 5, a typical color filter 50 includes a substrate 500, a black matrix 510 disposed on the substrate 500, and a patterned photo-resist layer disposed in and around holes of the black matrix 510. A transparent overcoat layer 530 is arranged on and covers the black matrix 510 and the photo-resist layer 520. The substrate 500 functions as a carrier of the above-described elements. The photo-resist layer includes a plurality of pixels 521. Each pixel 521 includes three sub-pixels: a red sub-pixel 522, a green sub-pixel 524, and a blue sub-pixel 526, all of which are arranged in a predetermined pattern. The black matrix 510 is disposed in and around the sub-pixels 522, 524 and 526.

The photo-resist layer is generally made from organic components, such as a polymer, a surfactant, pigment, and a monomer. However, the thermal resistance of the pigment is generally poor, which results in poor color reproduction of the color filter 50. In addition, diameters of the pigment particles are typically in the range from 5×10⁻⁸ meters to 2×10⁻⁷ meters. Therefore light scattering often occurs when light rays pass through the color filter 50, which results in reduced contrast and color transmittance.

What is needed, therefore, is a color filter that can overcome the above-described deficiencies.

### SUMMARY

In a preferred embodiment, a color filter for a liquid crystal display includes a substrate, a black matrix, and a photo-resist layer. The photo-resist layer defines a plurality of pixels. Each pixel includes a red sub-pixel, a green sub-pixel, and a blue sub-pixel. Each sub-pixel includes a plurality of nanoparticles. The black matrix is disposed in and around the sub-pixels.

The material of the nanoparticles can be metal, a semiconductor, and/or a semiconductor compound. Light transmission of the color filter can be controlled by configuring diameters and shapes of the nanoparticles accordingly. The color filter performs with high thermal resistance, high light transmission, and good contrast.

In other embodiments, fluorescence of a color filter can also be controlled by configuring the materials, the diameters, and the shapes of the nanoparticles accordingly.

Other advantages and novel features will become more apparent from the following detailed description when taken in conjunction with the accompanying drawings.

### BRIEF DESCRIPTION OF THE DRAWINGS

FIG. 1 is a schematic, side cross-sectional view of part of a color filter of a first preferred embodiment of the present invention.

FIG. 2 is a schematic, side cross-sectional view of part of a color filter of a second preferred embodiment of the present invention.

FIG. 3 is a schematic, side cross-sectional view of part of a color filter of a third preferred embodiment of the present invention.

FIG. 4 is a schematic, enlarged view in cross-section of a core/shell nanoparticle of the color filter of FIG. 3.

FIG. 5 is a schematic, side cross-sectional view of part of a conventional color filter.

### DETAILED DESCRIPTION OF PREFERRED EMBODIMENTS

Reference will now be made to the drawings to describe the preferred embodiments in detail.

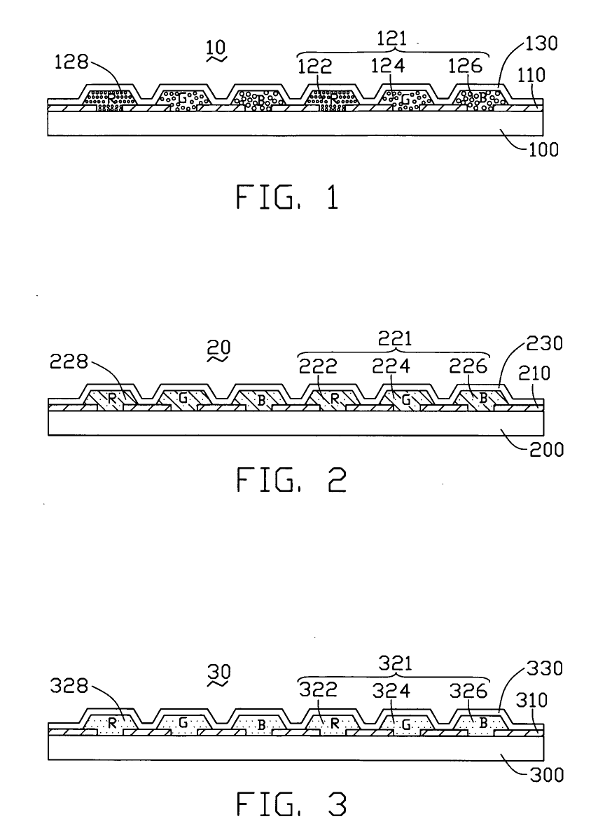

FIG. 1 is a schematic, side cross-sectional view of part of a color filter of the first preferred embodiment of the present invention. The color filter 10 includes a substrate 100, a black matrix 110 disposed on the substrate 100, and a patterned photo-resist layer (not labeled) disposed in and around the black matrix 110. A transparent overcoat layer 130 is arranged on and covers the black matrix 110 and the photo-resist layer. The substrate 100 functions as a carrier of the above-described elements. The photo-resist layer includes a plurality of pixels 121. Each pixel 121 includes three sub-pixels: a red sub-pixel 122, a green sub-pixel 124, and a blue sub-pixel 126, all of which are arranged in a predetermined pattern. The black matrix 110 is disposed in and around the sub-pixels 122, 124 and 126, for preventing light rays from mixing among adjacent sub-pixels 122, 124 and 126.

Each of the sub-pixels 122, 124, and 126 includes a plurality of nanoparticles 128. The nanoparticles 128 are made of metal or alloy, such as aluminum (Al), titanium (Ti), chromium (Cr), nickel (Ni), silver (Ag), zinc (Zn), molybdenum (Mo), tantalum (Ta), tungsten (W), copper (Cu), gold (Au), and/or platinum (Pt). The material, a diameter, and a shape of the nanoparticles 128 are selected according to the desired light transmission characteristics of the sub-pixel 122, 124, or 126. Preferably, A diameter of the nanoparticles 128 is in the range from 1×10⁻⁹ meters to 1×10⁻⁷ meters. The shape of the nanoparticles 128 can be cylindrical, columnar, pyramidal, prismatic, spherical, oval-shaped in cross-section, etc.

When white light reaches the black matrix 110 and the photo-resist layer, the red pixel 122 allows only red rays to pass therethrough. The green pixel 124 allows only green rays to pass therethrough. The blue pixel 126 allows only blue rays to pass therethrough. Thus, only three colored rays, namely red, green, and blue rays, pass through the color filter 10.

When the diameter of a particle approaches the nanometer level (1×10⁻⁹ meters), many physical, chemical, and magnetic characteristics of the particle change. For example, as the diameter of particles of Au decreases, the color of the transmission rays changes. When the diameter of the Au particles is about 2×10⁻⁷ meters, the color of the transmission rays is gold or orange. When the diameter of the Au particles is about 1×10⁻⁷ meters, the color of the transmission rays is green. When the diameter of the Au particles is about 2.6×10⁻⁸ meters, the color of the transmission rays is wine. With proper materials and diameters, the absorption spectra of the various nanoparticles 128 can be controlled, and desired colors such as RGB can be achieved.

FIG. 2 is a schematic, side cross-sectional view of part of a color filter of the second preferred embodiment of the present invention. The color filter 20 includes a substrate 200, a black matrix 210 disposed on the substrate 200, and a patterned photo-resist layer disposed in and around the black matrix 210. A transparent overcoat layer 230 is arranged on the black matrix 210 and the photo-resist layer. The substrate 200 functions as a carrier of the above-described elements. The photo-resist layer includes a plurality of pixels 221. Each pixel 221 includes three sub-pixels: a red sub-pixel 222, a green sub-pixel 224, and a blue sub-pixel 226, all of which are arranged in a predetermined pattern. The black matrix 210 is disposed in and around the sub-pixels 222, 224, and 226, for preventing light rays from mixing among adjacent sub-pixels 222, 224, and 226.

Each of the sub-pixels 222, 224, and 226 includes a plurality of nanoparticles 228. A material of the nanoparticles 228 is a semiconductor and/or a semiconductor compound. The material, a diameter, and a shape of the nanoparticles 228 are selected according to the desired transmission characteristics of the sub-pixel 222, 224, or 226.

The nanoparticles 228 typically have fluorescent characteristics. Therefore ultraviolet rays and certain visible light rays of high frequency can be absorbed by the nanoparticles 228, and be converted to visible light rays of low frequency. With proper selection of the materials and diameters, the absorption spectra of the various nanoparticles 228 can be controlled, and desired colors such as RGB can be achieved.

FIG. 3 is a schematic, side cross-sectional view of part of a color filter of the third preferred embodiment of the present invention. The color filter 30 includes a substrate 300, a black matrix 310 disposed on the substrate 300, and a patterned photo-resist layer disposed in and around the black matrix 310. A transparent overcoat layer 330 is arranged on the black matrix 310 and the photo-resist layer. The substrate 300 functions as a carrier of the above-described elements. The photo-resist layer includes a plurality of pixels 321. Each pixel 321 includes three sub-pixels: a red sub-pixel 322, a green sub-pixel 324, and a blue sub-pixel 326, all of which are arranged in a predetermined pattern. The black matrix 310 is disposed in and around the sub-pixels 322, 324 and 326, for preventing light rays from mixing among adjacent sub-pixels 322, 324 and 326.

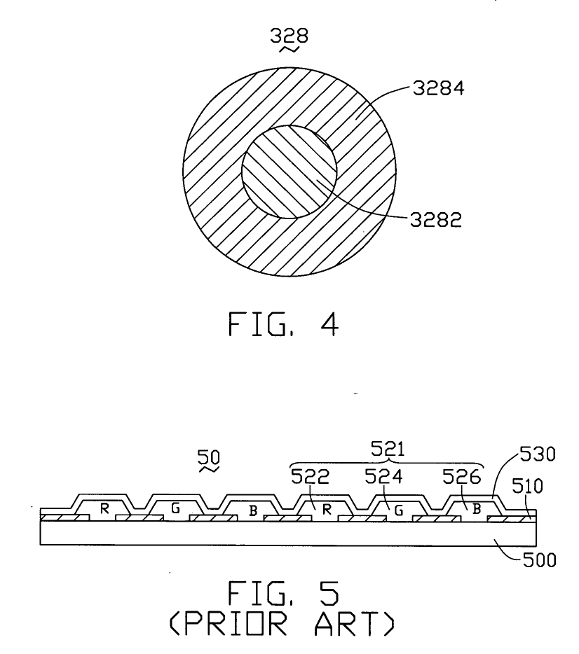

Each of the sub-pixels 322, 324, and 326 includes a plurality of nanoparticles 328. The nanoparticles 328 are core/shell type nanoparticles. Also referring to FIG. 4, each nanoparticle 328 includes a core 3282, and a shell 3284 surrounding the core 3282. A material, a diameter, and a shape of the nanoparticles 328 are selected according to the desired transmission characteristics of the sub-pixel 322, 324, or 326.

The core/shell type nanoparticles 328 are made from two kinds of material which have different energy gaps. Each of the two materials can be a semiconductor or a semiconductor compound. For example, the core 3282 can be made from ZnS, which has an energy gap of 3.7 eV; and the shell 3284 can be made from CrS, which has an energy gap of 2.5 eV. The shell 3284 can prevent the core 3282 from being contaminated by foreign material that would cause surface inactivation. Therefore the efficiency of fluorescence of the core 3282 is maintained or improved. Thus, the overall fluorescence efficiency of the core/shell type nanoparticles 328 is maintained or improved as well.

The color filters 10, 20, 30 use metal, semiconductor, and/or semiconductor compound nanoparticles as light absorption materials, all of which have improved thermal resistance. In addition, the diameters of the nanoparticles 128, 228, 328 are very small, so light scattering is reduced. Accordingly, the contrast and the color transmittance of the color filters 10, 20, 30 are improved. Furthermore, the fluorescent characteristics of the semiconductors and semiconductor compounds can convert ultraviolet rays and certain visible light rays of high frequency to visible light rays of low frequency, such as RGB rays. Thus, the light transmission ratio of the color filters 20, 30 is improved.

In alternative embodiments, the nanoparticles can for example be any combination of the above-described metals, alloys, semiconductor(s) and semiconductor compound(s).

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A color filter for a liquid crystal display, comprising:
a substrate;
a photo-resist layer defining a plurality of pixels, each pixel comprising a red sub-pixel, a green sub-pixel, and a blue sub-pixel, each sub-pixel comprising a plurality of nanoparticles; and
a black matrix disposed in and around the sub-pixels.

2. The color filter as claimed in claim 1, wherein a diameter of the nanoparticles is in the range from 1×10⁻⁹ meters to 1×10⁻⁷ meters.

3. The color filter as claimed in claim 1, wherein a material of the nanoparticles is metal.

4. The color filter as claimed in claim 3, wherein the metal is selected from the group consisting of Al, Ti, Cr, Ni, Ag, Zn, Mo, Ta, W, Cu, Au, and Pt.

5. The color filter as claimed in claim 3, wherein for each of the sub-pixels, the material of the nanoparticles is selected according to a desired transmission characteristic of the sub-pixel.

6. The color filter as claimed in claim 3, wherein for each of the sub-pixels, a diameter of the nanoparticles is selected according to a desired transmission characteristic of the sub-pixel.

7. The color filter as claimed in claim 3, wherein for each of the sub-pixels, a shape of the nanoparticles is selected according to a desired transmission characteristic of the sub-pixel.

8. The color filter as claimed in claim 1, wherein a material of the nanoparticles is a semiconductor or a semiconductor compound.

9. The color filter as claimed in claim 8, wherein for each of the sub-pixels, the material of the nanoparticles is selected according to a desired transmission characteristic of the sub-pixel.

10. The color filter as claimed in claim 8, wherein for each of the sub-pixels, a diameter of the nanoparticles is selected according to a desired transmission characteristic of the sub-pixel.

11. The color filter as claimed in claim 8, wherein for each of the sub-pixels, a shape of the nanoparticles is selected according to a desired transmission characteristic of the sub-pixel.

12. The color filter as claimed in claim 8, wherein the nanoparticles each comprise a core and a shell surrounding the core.

13. The color filter as claimed in claim 12, wherein an energy gap of the core is lower than an energy gap of the shell.

14. The color filter as claimed in claim 1, wherein the sub-pixels are arranged in a predetermined pattern.

15. The color filter as claimed in claim 1, wherein a shape of the nanoparticles is selected from the group consisting of cylindrical, columnar, pyramidal, prismatic, spherical, and oval-shaped in cross-section.

16. The color filter as claimed in claim 1, further comprising an overcoat layer disposed on the black matrix and the photo-resist layer.

17. The color filter as claimed in claim 16, wherein the overcoat layer is transparent.

18. A color filter for a liquid crystal display, comprising:
a substrate;
a photo-resist layer defining a plurality of pixels, each pixel comprising at least two of following items: a red sub-pixel, a green sub-pixel, and a blue sub-pixel,
each sub-pixel comprising a plurality of nanoparticles; and
a black matrix disposed in and around the sub-pixels.
